(19) United States
(12) Patent Application Publication
(10) Pub. No.: US 2009/0045183 A1
(43) Pub. Date: Feb. 19, 2009

(54) Welding Torch and End Piece as Well as Contact Tube for a Welding Torch

(76) Inventors: Josef Artelsmair, Wartberg/Krems (AT); Andreas Leonhartsberger, Florian/Linz (AT); Jorg Kazmaier, Neuried-I (DE)

Correspondence Address: COLLARD & ROE, P.C., 1077 NORTHERN BOULEVARD, ROSLYN, NY, 11576, US

(21) Appl. No.: 12/086,366

(22) PCT Filed: Nov. 28, 2006
(86) PCT No.: PCT/AT2006/000488

§ 371 Date: Jun. 12, 2008

(30) Foreign Application Priority Data
Dec. 12, 2005 (AT) A 1977/2005

(51) Int. Cl. B23K 9/28

(52) U.S. Cl. 219/137.44

(57) ABSTRACT

The invention relates to a welding torch (10) having a torch body (46) in which at least one device (32) for feeding a welding wire (13) and a contact tube (30) having a bore (33) and a guide bore (34), running concentrically thereto, for guiding the welding wire (13) in the direction of a workpiece (16) are arranged, wherein the welding wire (13) can be supplied with electrical energy via the contact tube (30), wherein one end of the feed device (32) is arranged in the guide bore (34) of the contact tube (30) and is provided with an electrically conductive end piece (36) having a bore (40) for the welding wire (13). To provide such a welding torch (10) in which the durability or the service life of the wearing parts, in particular of the contact tube (30), is prolonged, provision is made for the end piece (36) of the feed device (32) to be movably arranged in the guide bore (34) of the contact tube (30).

The invention relates to a welding torch having a torch body, in which at least one device for feeding a welding wire and a contact tube having a bore and a guide bore, running concentrically thereto, for guiding the welding wire in the direction of a work piece are arranged, wherein the welding wire can be supplied with electrical energy via the contact tube, wherein one end of the feed device is arranged in the guide bore of the contact tube and is provided with an electrically conductive end piece having a bore for the welding wire.

Likewise, the invention relates to an end piece for a device for feeding a welding wire into a welding torch, which end piece is fastenable to that end of the feed device that is positioned in the guide bore of a contact tube.

Furthermore, the invention also relates to a contact tube having a bore for the welding wire and a guide bore for receiving the welding wire fed and for forwarding to the bore.

Welding torches with a contact tube fastened substantially thereto have been known, in which an electrical contact with a welding wire fed through an inner bore of the contact tube is established. Here, the welding wire is guided to the welding torch through a so-called “core”, one end of the core preferably being received by one bore in the contact tube. Within the contact tube, the bore for the end of the core is connected with the inner bore for the welding wire such that the welding wire may be guided into the inner bore by the core and contacted.

In this context, it is disadvantageous that the abrasion produced by the conveyance of the welding wire is directly conveyed into the inner bore of the contact tube by the core, thus causing a “narrowing” and a reduction in the diameter of the bore of the contact tube. Consequently, the contact tube has to be regularly exchanged and cleaned. Likewise, it is disadvantageous that the twist of the welding wire fed cannot be compensated for because of the usually firm fixing of the end of the core within the bore of the contact tube. Optionally, this leads to an increase in the conveying power for the welding wire, negatively affecting the quality of the welding wire, causing additional abrasion and, thus, causing the inner bore to narrow more quickly.

From WO 99/30863 A1 it has been known to fasten a transition element to that end of a welding-wire guiding device which is received by a contact tube. The object of this transition element is to appropriately align the welding wire such that the latter passes into a bore of the contact tube with only small so-called bending.

U.S. Pat. No. 6,495,798 B1 also shows a transition element of a guiding device for the welding wire to a contact tube, wherein the abrasion of the welding is relatively high so that the contact tube has to be exchanged quite often.

Finally, WO 2003/039800 A1 shows a contact tube having a bore for guiding the welding wire, with no measures being taking for preventing the “narrowing” due to abrasion of the welding wire either.

In this context, it is disadvantageous that the transition element is fixedly connected with the contact tube such that, e.g. an increased bending causes more abrasion since the bending can only be aligned and not be compensated for. Then, the abrasion deposits within the contact tube and causes a narrowing, thus substantially reducing the service life of the contact tube. Likewise, it is disadvantageous that the transition element is made of a non-conductive material, whereby no secondary contacting of the welding wire can occur. Thus, the risk that the welding wire “ties up” in the contact tube is increased.

An object of the invention resides in providing an above-mentioned welding torch, wherein the service life of the wearing parts, particularly the contact tube, is substantially increased. Another object of the invention is to provide an end piece and a contact tube for such a welding torch, the service life of which being as long as possible.

The first object of the invention is achieved by an above-mentioned welding torch, the end piece of the feeding device being movably arranged in the guide bore of the contact tube.

The electrically conductive end piece of the feeding device is an extension of the contact tube, whereby the service life of the contact tube is substantially increased. This is mainly achieved in that a major part of the abrasion caused by the conveyance of the welding wire will be deposited already in the bore of the end piece and, thus, hardly any depositions will occur in the bore of the contact tube, thus substantially avoiding a narrowing and reduction of the diameter of the bore of the contact tube. The electrical conductivity of the end piece is a substantial advantage, since a second electrically conductive connection, a so-called “secondary contact” with low transfer resistance to the welding wire, is established by means thereof. When contacting in the bore of the contact tube fails, this second electrically conductive connection ensures the current/energy transfer to the welding wire. Additionally, it is advantageous that the current load for the contact tube is substantially reduced during a welding process. By the measure of movably arranging the end piece within the contact tube, it is achieved that the end piece is deflected, i.e. is inclined relative to the contact tube, when the welding wire is being conveyed, whereby a curved course of the welding wire is formed and the abrasion deposits in this region. Thus, the conveying power of the welding wire can be reduced and/or kept constant. Thus, the end piece and the end region of the feeding device adapt to the twist of the welding wire.

If an electrical connection is established between the contact tube and the end piece so that an additional current transfer to the welding wire is effected with low electrical resistance, it will be advantageously achieved that the secondary contact of the welding wire takes place within the electrically conductive end piece in a concentrated manner, thus substantially minimising the thermal stress of the feeding device.

It is also advantageous that the end piece of the feeding device is rotatably and movably arranged in the guide bore of the contact tube.

Advantageously, the feeding device has an inner bore for conveying the welding wire, the diameter of which being larger than the diameter of the bore of the end piece, and the diameter of the bore of the contact tube being smaller than that of the bore of the end piece. By the measure that the diameter of the bore of the end piece is adjusted to the respectively used diameter of the welding wire, an automated threading is facilitated since the diameter of the bore is reduced in a step-wise manner.

According to a further feature of the invention, the diameter of the bore of the end piece is larger than the diameter of the welding wire by between 20 and 50 percent, particularly 30 percent.

If the feeding device is arranged eccentrically on the contact tube so that the central axis of the bore of the end piece is inclined relative to the central axis of the bore of the contact tube, a safe current transfer to the welding wire may be achieved in the bore of the contact tube.

It is also of advantage that the end piece, on one end, has a transition zone for receiving one end of the feeding device. Thus, a simple fastening is achieved since the transition zone of the end piece is plugged to the feeding device in a simple manner.

In this context, the diameter dimensions are advantageously such that the plug connection ensures a safe connection and that the former can be established with little effort. Here, the connection between the transition zone of the end piece and the feeding device can be designed to be fixed or detachable. By using a detachable connection, e.g. a screwing connection, it is advantageously achieved that a simple and rapid exchange of the end piece is rendered possible.

According to a further feature of the invention, the end piece has a web on the end opposing the transition zone. This web can be designed to be a centring ring for the guide bore, the outside diameter of the web being slightly smaller than the diameter of the guide bore of the contact tube. Thus, a passing of the welding wire from the bore of the end piece to the bore of the contact tube is ensured with low friction.

The web and the transition zone may be connected with each other by means of a connecting member.

In this context, the connecting member preferably has a smaller outside diameter than the web.

The outside diameter of the end piece is preferably designed to be tapering from the transition zone in the direction of the web towards the connecting member.

The recess may conically pass into the bore of the end piece.

By the measure that the whole web and a portion of the connecting member of the end piece project into the guide bore of the contact tube, a corresponding clearance is provided within the guide bore such that the end piece may appropriately move, in particular rotate and/or pivot. Here, the web and the connecting member are electrically connected with the guide bore such that an inclined position, or the described inclination, of the end piece in the guide bore of the contact tube is achieved due to the eccentric arrangement of the feeding device, thus providing a safe contact point of the welding wire so that a current transfer from the contact tube to the electrically conductive end piece and, correspondingly, to the welding wire will occur. Thus, it is achieved that a movable extension of the contact tube is provided by means of the electrically conductive end piece. This would not be possible with a contact tube, or a single-piece contact tube, known from the prior art.

It is also advantageous that the feeding device, at least in the region of the fixing thereof to the end piece, is designed to be flexible, particularly by means of a flexible coil, since this measure facilitates movability of the end piece within the guide bore and ensures a current transfer from the contact tube and the end piece to the welding wire. This also allows the feeding device to be eccentrically arranged, since the flexible design of the end region facilitates an easy deflection and rotational movement of the end piece within the contact tube.

The feeding device, at least in the region of the fixing thereof to the end piece, is formed by a material having a high thermal resistance. Thus, a thermal isolation of the end piece and the feeding device can be achieved, preventing a thermal destruction of the feeding device, which may consist, e.g. of plastics or graphite.

The object of the invention is also achieved by an above-mentioned end piece, which is formed by an electrically conductive material and is provided with a bore for the welding wire.

Advantageously, the end of the end piece facing the guide bore of the contact tube is designed for a movable connection of the end piece within the guide bore of the contact tube.

Advantageously, the end piece has the features described above.

The advantages resulting therefrom can be learned from the advantages already described.

The object of the invention is also achieved by an above-mentioned contact tube, wherein the transition zone between the guide bore and the bore is formed by a recess for receiving an end piece of a device for feeding a welding wire.

In this context, the recess may be spherical such that the end piece including a sphere on one end fits into the recess.

Here, the diameter of the sphere of the end piece is slightly smaller than the diameter of the recess in the contact tube.

Advantageously, the end piece has the features mentioned above.

The advantages resulting therefrom can also be learned from the advantages already described.

The present invention will be described in more detail by way of the enclosed schematic drawings.

Therein:

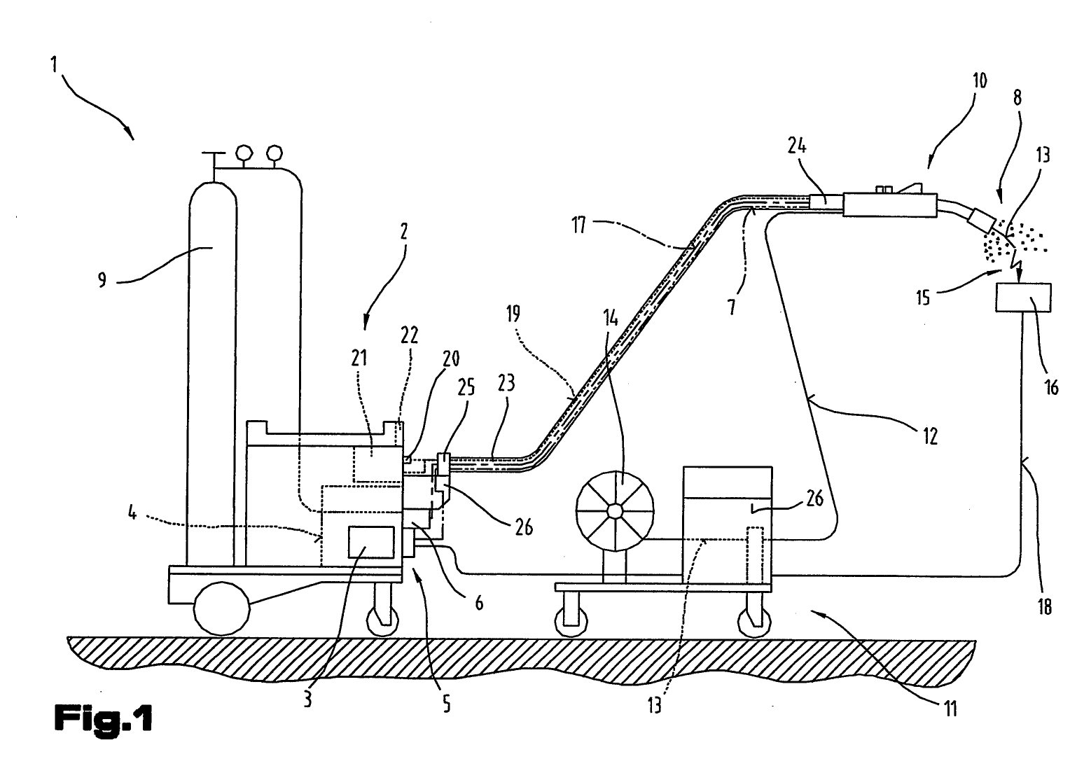

FIG. 1 is a schematic representation of a welding machine or a welding device;

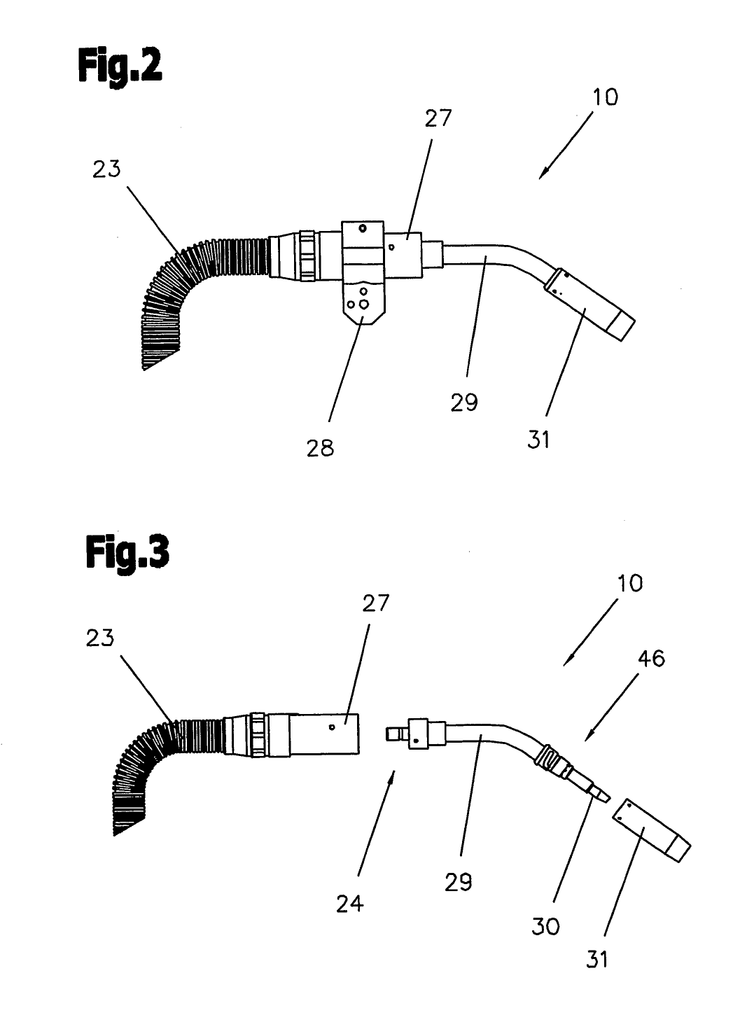

FIG. 2 is a schematic side-view of a welding torch;

FIG. 3 is an explosion view of the welding torch according to FIG. 2;

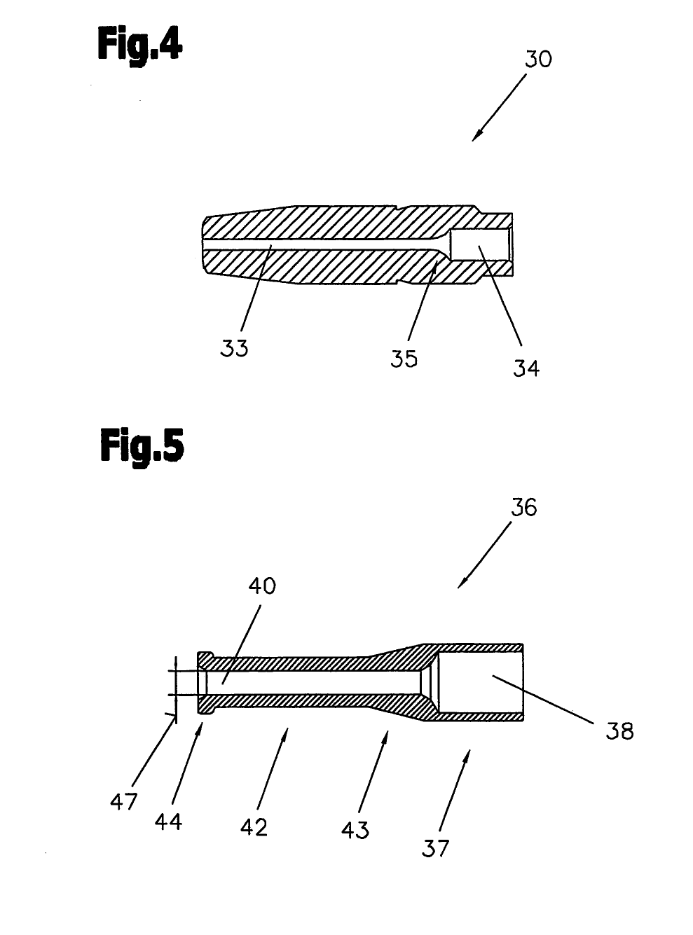

FIG. 4 is a schematic sectional representation of a contact tube;

FIG. 5 is a schematic sectional representation of the inventive end piece;

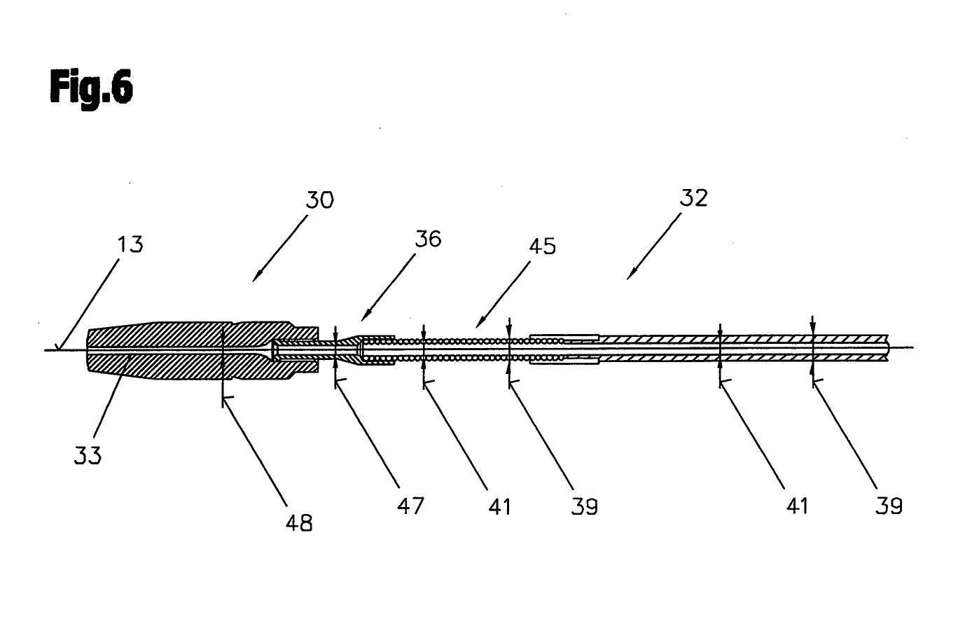

FIG. 6 is a schematic sectional representation of a feeding device including the inventive end piece in the contact tube;

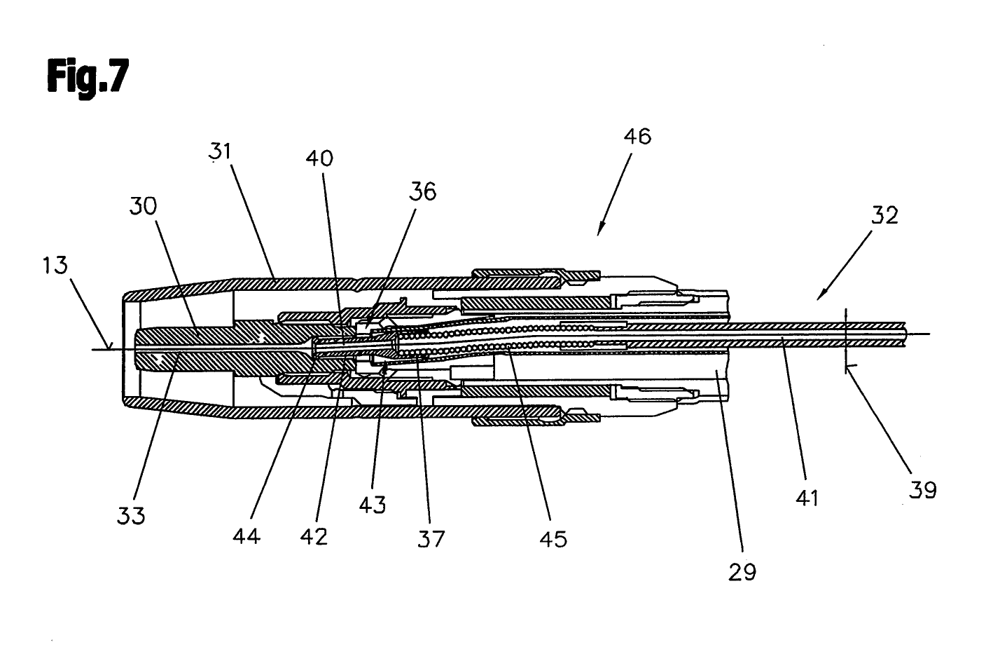

FIG. 7 is a schematic sectional representation of a torch body of a welding torch including a feeding device arranged therein, comprising the inventive end piece, in the contact tube during a welding process;

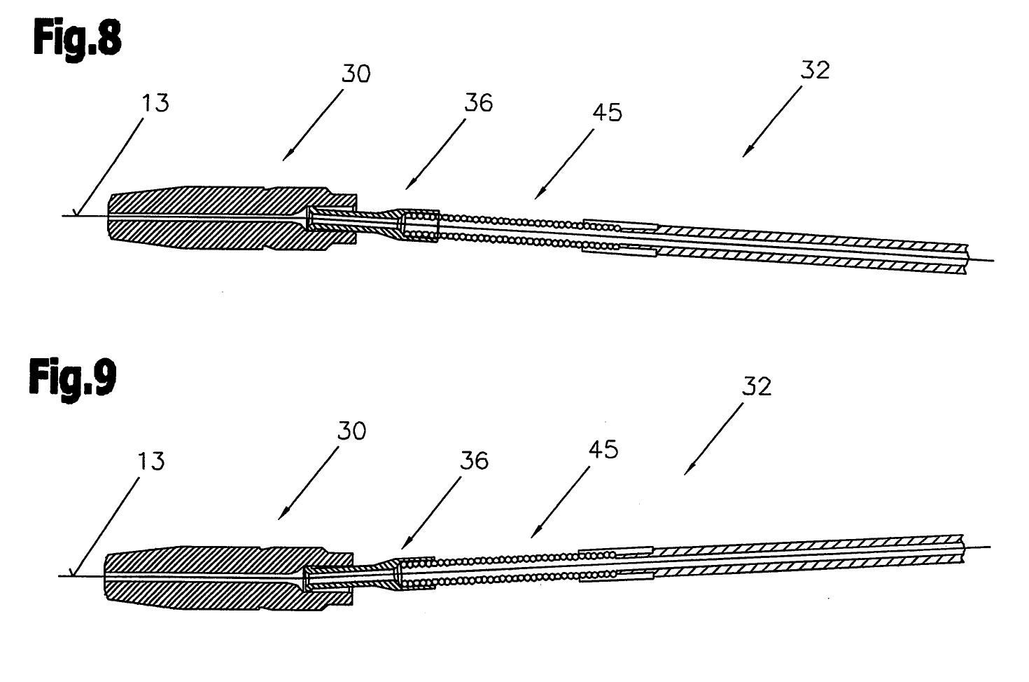

FIG. 8 is a schematic representation of a feeding device during a welding process in the contact tube including the inventive end piece;

FIG. 9 is a further schematic representation of a feeding device including the inventive end piece in the contact tube during a welding process;

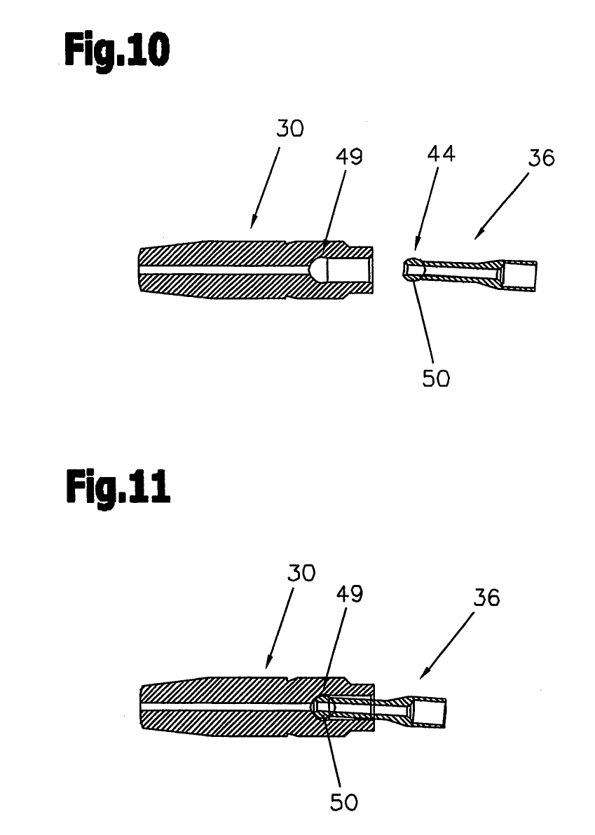

FIG. 10 is a schematic representation of a further exemplary embodiment of the end piece as part of the contact tube; and

FIG. 11 shows the end piece as part of the contact tube according to FIG. 10 in the assembled state.

Initially, it is pointed out that same parts of the exemplary embodiment will have the same reference numbers.

FIG. 1 depicts a welding device 1 or welding plant for the most various welding processes or methods such as, e.g., MIG/MAG welding or WIG/TIG welding, or electrode welding methods, double-wire/tandem welding methods, plasma or soldering methods etc.

The welding device 1 comprises a power source 2 including a power element 3, a control device 4, and a switch member 5 associated with the power element 3 and the control device 4, respectively. The switch member 5 and the control device 4 are connected to a control valve 6 arranged in a feed line 7 for a gas 8, in particular, a protective gas such as, e.g., CO₂, helium or argon and the like, between a gas reservoir 9 and a welding torch 10, or torch.

Besides, a wire feeder 11 as is usually employed in MIG/MAG welding can also be activated by the control device 4, wherein additional material or welding wire 13 is fed from a feed drum 14, or wire coil, into the region of the welding torch 10 via a feed line 12. It is, of course, possible to integrate the wire feeder 11 in the welding device 1 and, in particular, in its basic housing, as is known from the prior art, rather than designing the same as an accessory device, as is illustrated in FIG. 1.

It is also feasible for the wire feeder 11 to supply the welding wire 13, or additional material, outside the welding torch 10 to the process site, to which end a non-consumable electrode is preferably arranged in the welding torch 10, as is usually the case with WIG/TIG welding.

The power for building up an electric arc 15, particularly an electric arc for welding, between the non-consumable electrode (not illustrated) and a work piece 16 is supplied from the power element 3 of the power source 2 to the welding torch 10 and, in particular, to the electrode via a welding line 17, wherein the work piece 16 to be welded, which is formed of several parts, is likewise connected with the welding device 1 and, in particular, power source 2 via a further welding line 18, thus enabling a power circuit for a process to build up over the electric arc 15 or plasma jet formed.

To provide cooling of the welding torch 10, the welding torch 10 may be connected with a fluid reservoir and, in particular, with a water reservoir 21 by a cooling circuit 19 via an interposed flow control 20, whereby the cooling circuit 19 and, in particular, a fluid pump used for the fluid contained in the water reservoir 21, is started as the welding torch 10 is put into operation, in order to effect cooling of the welding torch 10.

The welding device 1 further comprises an input and/or output device 22, via which the most different welding parameters, operating modes or welding programs of the welding device 1 can be set and called, respectively. In doing so, the welding parameters, operating modes or welding programs set by the input and/or output device 22 are transmitted to the control device 4, which, in turn, will subsequently activate the individual components of the welding plant or welding device 1, and predefine the respectively desired control values.

In the exemplary embodiment illustrated, the welding torch 10 is, furthermore, connected with the welding device 1 or welding plant via a hose pack 23. The hose pack 23 accommodates the individual lines leading from the welding device 1 to the welding torch 10. The hose pack 23 is connected with the welding torch 10 via a coupling device 24, whereas the individual lines arranged within the hose pack 23 are connected with the individual contacts of the welding device 1 via connection sockets or plug-in connections. In order to ensure an appropriate strain relief of the hose pack 23, the hose pack 23 is connected with a housing 26 and, in particular, the basic housing of the welding device 1 via a strain relief means 25. It is, of course, possible to use the coupling device 24 also for the connection to the welding device 1.

Basically, it is to be noted that not all of the aforementioned components need be used or employed in the various welding methods or welding devices 1, such as, e.g., WIG devices or MIG/MAG devices or plasma devices. In this context it is, for instance, feasible to design the welding torch 10 as an aircooled welding torch 10.

FIGS. 2 and 3 show a highly simplified structure of a welding torch 10 formed by a customary MIG torch. FIG. 2 illustrates the welding torch 10 in the assembled state, having a retainer 28 arranged on a retaining member 27 or torch handle, for an automatic insertion, particularly of a robot welding plant, which can be omitted with a manually operated welding torch 10. FIG. 3 shows the essential components of the welding torch 10 in an exploded view, namely the hose pack 23, the retaining member 27, a pipe bend 29, a torch body 46, a contact tube 30 and a gas nozzle 31.

The hose pack 23 is connected with the pipe bend 29 via a coupling device 24. The retaining member 27 is designed as a part of the hose pack 23. Of course, the retaining member 27 can also be designed as a component of the pipe bend 29, and the hose pack 23 be fixedly connected with the retaining member 27, or a burner shell or burner handle, and with the pipe bend 29 via a coupling device 24. The pipe bend may likewise be connected with the retaining member 27 via the coupling device 24 or another coupling known from the prior art.

The pipe bend 29 includes, i.a., cooling channels, supply lines for electrical energy, supply lines for the gas 8 and, in particular, a feed device 32 for the welding wire 13, the so-called “core”, which is fed to the pipe bend 29 via the hose pack 23.

Preferably, the feed device 32 is arranged in the hose pack 23 and, thus, replaces the supply line 12 of FIG. 1. Hence, the feed device 32 receives the welding wire 13 at the strain-relief means 25, to which the hose pack 23 is connected, and guides the same to a contact tube 30 in the welding torch 10. The feed device 32 comprises an inner bore 41, through which the welding wire 13 is conveyed to the contact tube 30 by the wire feeder 11. In the contact tube 30, the welding wire 13 is supplied with electrical energy such that a welding process can be carried out.

According to FIG. 4, the contact tube 30 comprises a bore 33 for the welding wire 13 and a guide bore 34 for the feed device 32. The diameter of the bore 33 is substantially adjusted to the diameter of the welding wire 13, and the diameter of the guide bore 34 is substantially adjusted to the outside diameter 39 of the feed device 32. Thus, the feed device 32 can be introduced into the guide bore 34 of the contact tube 30 or enter the same, respectively, such that there is an exact alignment of the bore 40 of the end piece 36 of the feed device 32 relative to the contact tube 30. Thus, the welding wire 13, when leaving the end piece 36 of the feed device 32, passes into the bore 33 of the contact tube 30 in a low-friction and centrical manner. Additionally, the transition zone from the guide bore 34 to the bore 33 may be formed by a conical tapering 35, thus avoiding sharp edges and facilitating the introduction of the welding wire 13.

The contact tube 30 is made of an electrically conductive material, e.g. copper, and preferably is fastened to the torch body 46. This fastening is reached, e.g. via a screw connection. When activating a welding process, the contact tube 30 is supplied with electrical energy. By the measure that the welding wire 13 contacts the contact tube 30 in the bore 33, the contact tube is supplied with electrical energy. Thus, by means of known ignition methods, e.g. contact ignition, the electric arc 15 may be ignited between the welding wire 13 and the work piece 16, and the welding process can be carried out.

For a welding process with a consumable electrode and a welding wire 13, the latter needs to be conveyed via the feed device 32. Here, the welding wire 13 can be conveyed continuously or discontinuously, as is the case with the CMT method known. An abrasion of the welding wire 13 will necessarily occur when conveying the welding wire 13 through the hose pack 23 and/or the feed device 32. The amount of this abrasion created mainly depends on the power transferred from the wire feeder 11 to the welding wire 13 and on the length of the welding 13 conveyed. The abrasion contacts the contact tube 30 as soon as the welding wire 13 in the guide bore 34 leaves the feed device 32, particularly in the bore 33 of the contact tube 30. Additionally, the abrasion causes a “narrowing” of the contact tube 30 in a manner known. This “narrowing” causes, in particular, a reduction of the diameter of the bore 33.

This means that the diameter of the bore 33 is reduced during the ongoing welding process. This may result in that the conveying power for the welding wire 13 has to be increased, leading to a “tie-up” of the welding wire 13 in the bore 33 or a sticking of the welding wire 13 in the bore 33. To prevent a negative effect on the quality of the weld seam, the welding process has to be interrupted and the contact tube 30 to be cleaned or, preferably, exchanged.

According to the invention, the contact tube 30 is replaced by a contacting system which is formed by an end piece 36 fastened to one end of the feed device 32 and by the contact tube 30. This end piece 36 is received by the guide bore 34 and substantially effects an extension of the contact tube 30. Preferably, the end piece 36 is made of the same material as the contact tube 30 used.

In the following, the inventive contacting system will be schematically illustrated by means of FIGS. 5 to 9.

FIG. 5 shows a sectional schematic representation of the end piece 36. The end piece 36, on one end, comprises a transition zone 37 to the feed device 32. Via this transition zone 37, the end piece 36 is connected with the feed device 32. For this purpose, the transition zone 37 comprises a substantially cylindrical recess 38, the diameter of which substantially corresponding to the outside diameter 39 of the feed device 32. Likewise, the recess 38 is designed in a manner substantially corresponding to the end of the feed device 32 such that the transition zone 37 can receive the feed device 32 and that the latter may be fixed appropriately. Preferably, the end piece 36 is fastened to the end of the feed device 32 via the transition zone 37 by a pressfitting connection. Likewise, the fastening of the end piece 36 may also be effected via a detachable connection, particularly a screw connection.

Due to the fastening of the end piece 36 to the feed device 32, the welding wire 13 can pass the end piece 36 via a bore 40 and can be received by the contact tube 30. Here, the recess 38 preferably passes conically into the bore 40 such that the welding wire 13 may pass from the feed device 32 into the bore 40 with low friction in a smooth manner and such that an additional abrasion of the welding wire 13 will be reduced. Furthermore, the diameter of the bore 40 is preferably smaller than the diameter of the inner bore 41 of the feed device 32.

The passing inside the end piece 36, from the recess 38 to the bore 40, is effected in a conical manner as likewise is the passing outside the end piece 36, from the transition zone 37 to a connecting member 42, preferably via a conical tapering 43. The outside diameter of the connecting member 42 is preferably smaller than the diameter of the guide bore 34 of the contact tube 30. Moreover, the free end of the connecting member 42 may be provided with a web 44. Here, the web 44 has an outside diameter which substantially corresponds to the diameter of the guide bore 34 or is slightly smaller. Thus, an intermediate space is created between the end piece 36 and the guide bore 34 of the contact tube 30, due to which the end piece 36 is movable within the guide bore 34.

The contact tube 30 may, thus, receive the connecting member 42 of the end piece 36, to which the feed device 32 is fastened, as is illustrated in FIG. 6. Here, only a portion of the connecting member 42, e.g. three quarters thereof, is received by the guide bore 34 of the contact tube 30, which is why the end piece 36 is movable in the guide bore 34. The diameter of the bores, within which the welding wire 13 is guided, i.e. the diameter of the inner bore 41, the diameter 47 of the bore 40 and the diameter 48 of the bore 33 become smaller and smaller in the conveying direction. The bore 33 of the contact tube 30 has the smallest diameter 48, which usually is only slightly larger than the diameter of the welding wire 13. The diameter of the inner bore 41 of the feed device 32 usually is larger than the diameter 48 of the bore 33 in the contact tube 30. The diameter 47 of the bore 40 of the end piece 36 ranges between the diameter of the inner bore 41 of the feed device 32 and the diameter 48 of the bore 33. Furthermore, the diameters are appropriately adjusted to the diameter of the welding wire 13, the diameter of the bore 40 of the end piece 36 preferably being larger than the diameter of the welding wire 13 by 20 to 50 percent, particularly 30 percent.

The abrasion of the welding wire 13 caused when conveying the welding wire 13 in the feed device 32 deposits preferably in the bore 40 of the end piece 36.

This is supported by the measure that the feed of the feeding device 32 is effected eccentrically of the central axis of the bore 33 of the contact tube 30, as is illustrated in FIGS. 7 to 9. Here, the bore 40 of the end piece 36 is substantially inclined to a certain degree relative to the bore 33 of the contact tube 30, which results from the eccentrical feed of the feed device 32. Thus, a curved course of the feed device 32, and, thus, of the welding wire 13, results in the region of the end piece 36, whereby the deposition of the abrasion substantially in the bore 40 of the end piece 36 is caused and supported.

The deposition of the abrasion is additionally supported by the measure that the end piece 36 is made of the same material as the contact tube 30. Thus, hardly any abrasion gets into the bore 33 of the contact tube 30, whereby its service life is substantially increased without deteriorating the welding quality. Thus, the known “narrowing” of the contact tube 30 is shifted to the end piece 36. Since, compared to the diameter 48 of the bore 33 of the contact tube 30, there is more space for the abrasion in the end piece 36 due to the larger diameter 47 of the bore 40, the abrasion in the end piece 36 has few negative effects on the welding process. Moreover, the “narrowing” in the end piece 36 has less negative effects on the conveyance of the welding wire 13, thus allowing for the conveying power of the welding wire 13 to be kept approximately constant and for the quality of the welding wire to remain approximately at the same level.

Furthermore, the end piece 36 causes a so-called “forced contacting” of the welding wire 13 in the bore 33 of the contact tube 30, as can be seen particularly in FIGS. 8 and 9. The forced contacting is substantially achieved by the curved course of the feed device 32 in the region of the end piece 36, thus reaching a contacting of the welding wire 13 in the bore 33 in a forced and specific manner. Additionally, the forced contacting is facilitated by the web 44 on the end piece 36 serving as a centring ring, since thereby a safe passing of the welding wire 13 from the bore 40 into the bore 33 is ensured. Moreover, the inclination of the end piece 36, and the curved course of the welding wire, are achieved in that the feed device 32 is formed by a so-called “combined core” and the inventive end piece 36. Accordingly, the feed device 32 preferably substantially consists of graphite, wherein the last few centimetres are replaced by a flexible coil 45 made of metal or a metal alloy, e.g. CuAl, to which coil the end piece 36 is fastened. By this flexible arrangement of the end piece 36 in the guide bore 34 of the contact tube 30 it is achieved that the end piece 36 may substantially rotate and/or pivot in the guide bore 34. Thus, the twist the welding wire 13 may be compensated for, since the position of the end piece 36 in the guide bore 34 changes. Furthermore, by the rotational movement it is achieved that the power for conveying the welding wire 13 remains approximately constant. Since this, e.g. reduces the abrasion, it has positive effects on the welding properties and the service life of the wearing parts, such as the contact tube 30, the end piece 36 or the feed device 32.

Furthermore, the conveying power exerted on the welding wire 13 prompts the end piece 36 and the connecting member 42 to be pressed against the current-bearing guide bore 34 of the contact tube 30, in case that this has not already been caused by the eccentrical feed of the feed device 32 and the inclination resulting therefrom. Accordingly, there is a continuous current transfer from the contact tube 30 to the electrically conductive end piece 36 such that a so-called “secondary contacting” of the welding wire 13 occurs in the bore 40 of the end piece 36. This means that the secondary contacting is effected in the end piece 36, whereas the contacting essential for the welding process still occurs in the contact tube 30.

For example, the twist of the welding wire 13 may, however, result in that there will be no or only a poor contacting in the contact tube 30. This may often lead to a “tie-up” of the welding wire 13, wherein the welding wire 13 fuses with the contact tube in the bore 33 and cannot be conveyed any longer. Consequently, the welding process necessarily has to be stopped. This “tie-up” is prevented by the secondary contacting in the end piece 36, since the welding wire 13 is also contacted in the case that the welding wire 13 is not contacted in the bore 33 of the contact tube 30. Here, the current transfer advantageously occurs in the end piece 36 with a low specific resistance, as is the case with the contacting in the contact tube 30 as well. Thus, there will be no negative effects on the welding process, since the welding wire 13 is always charged or supplied with the current necessary for the welding process.

Furthermore, the current transfer to the welding wire 13 is divided up into the contact tube 30 and the end piece 36, i.e. into two parts, thus reducing the total wearing and, in particular, increasing the service life of the contact tube 30. This current transfer from the contact tube 30 to the end piece 36 is additionally supported by the measure that the end piece 36 and the contact tube 30 are preferably made of the same material. Thus, the current transfer to the welding wire 13 is concentrated in the region of the contact tube 30, thus minimising the thermal stress on the graphite part of the feed device 32. In addition, the thermal stress is minimised by the measure that the material of the feed device 32, and, in particular, the flexible coil 45, have a high thermal resistance. Thus, due to the minimised thermal stress on the feed device 32, the friction coefficient remains substantially the same, ensuring the welding wire 13 to be conveyed in an approximately constant fashion. Likewise, the abrasion of the welding wire 13 is, thus, substantially minimised and the risk of a “tie-up” of the welding wire 13 is significantly reduced.

Of course, the inventive end piece 36 may also be directly connected with the graphite part of the feed device 32 and the flexible coil 45 be omitted. This may be of advantage for specific applications and when using specific welding wires 13.

Finally, it should be mentioned that there is still wear of the contact tube 30 due to the high current density during the welding process. To a great extent, this wear depends on the level of the current strength required for a certain welding process. This is why it is necessary to replace the contact tube 30 after a certain number of welding steps and a certain duration of one or several welding steps. This cycle is substantially prolonged by using the end piece 36, since the end piece 36 substantially prevents that the contact tube 30 is “narrowed” with the abrasion of the welding wire 13. Of course, the “narrowing” in the end piece 36 results in the need for the latter to be exchanged after a certain time. Yet, since the feed device 32 is also a wearing part, the end piece 36 is exchanged preferably together with the feed device 32. However, it should be mentioned in this context that the contact tube 30 has to be exchanged more often than the feed device 32.

This also results in that the wear of the end piece 36 and of the feed device 32 and of the contact tube 30 is adjusted to the welding process. That is to say, e.g., whenever the contact tube 30 has been exchanged for the tenth time, also the feed device 32 including the inventive end piece 36 has to be exchanged, with no resources being wasted and no wearing parts being exchanged at a too early stage.

In a further embodiment of the contacting system for the welding wire 13, formed by the contact tube 30 and the end piece 36, according to FIGS. 10 and 11, the end piece 36 may also be a part of the contact tube 30. Here, e.g. the conical tapering 35 in the contact tube 30 (cf. FIG. 4) is replaced by a substantially spherical recess 49 which constitutes the smooth passing for the welding wire 13 into the bore 33 of the contact tube 30. Instead of the web 44 of the end piece 36 according to FIG. 5, the end of the end piece 36 according to FIGS. 10 and 11 is designed as a sphere 50 which fits into the recess 49 in the contact tube 30. For this purpose, it is, of course, necessary that the diameter of the recess 49 is slightly larger than the diameter of the sphere 50. A secure fastening of the end piece 36 in the recess 49 can be effected by different mechanical fixing devices, e.g. a locking ring.

Apart from the described modifications of the contact tube 30 and the end piece 36, these wearing parts, as described in FIGS. 1 to 9, remain unmodified so that the respective description also applies to this embodiment.

Thus, the contact tube 30 is formed by two parts and is a wearing part, wherein the functions of the individual wearing parts are combined in the two-piece contact tube 30 in the same manner.

The feed device 32 could also be included as third part of the contact tube 30. This is of particular advantage if the wear of the contact tube 30, of the end piece 36 and of the feed device 32 is substantially the same so that they may also be quickly exchanged.

Furthermore, the contact tube 30 may also be designed to be one part, wherein a shoulder with a bore for the welding wire 13 is arranged on the side where the wire is introduced, said shoulder being deformed by mechanical processing. That is to say, the shoulder is bent such that it has a preferably curved course and, thus, forms an angular position relative to the central axis of the contact tube 30. In this manner it is again achieved that the welding wire 13 is supplied eccentrically transversely relative to the central axis of the contact tube 30 and, thereafter, is deflected in the mechanically processed shoulder in the direction of the bore 33 of the contact tube 30, whereby, again, a secondary contact forms in the shoulder. Here, in the shoulder, it is not necessary that the contact tube 30, in addition to the bore 33 for the welding wire 13, also comprises a guide bore 34. Here, a portion of the bore may, however, be designed such that the feed device 32 and, in particular, the core, may be inserted into the shoulder. Again, the feed device 32 may also comprise an end piece 36 which can be inserted into the shoulder of the contact tube 30.

1-26. (canceled)

27. A welding torch (10) having a torch body (46), in which at least one device (32) for feeding a welding wire (13) and a contact tube (30) having a bore (33) and a guide bore (34), running concentrically thereto, for guiding the welding wire (13) in the direction of a work piece (16), are arranged, wherein the welding wire (13) can be supplied with electrical energy via the contact tube (30), wherein one end of the feed device (32) is arranged in the guide bore (34) of the contact tube (30) and is provided with an electrically conductive end piece (36) having a bore (40) for the welding wire (13), wherein the end piece (36) of the feed device (32) is rotatably and pivotally arranged in the guide bore (34) of the contact tube (30).

28. The welding torch (10) according to claim 27, wherein an electrical connection is formed between the contact tube (30) and the end piece (36) so that there is an additional current transition within the end piece (36) to the welding wire (13) with a low electrical resistance.

29. The welding torch (10) according to claim 27, wherein the feed device (32) has an inner bore (41) for conveying the welding wire (13), the diameter of said inner bore being larger than the diameter of the bore (40) of the end piece (36), and the diameter of the bore (33) of the contact tube (30) being smaller than that of the bore (40) of the end piece (36).

30. The welding torch (10) according to claim 27, wherein the diameter of the bore (40) of the end piece (36) is larger than the diameter of the welding wire (13) by between 20 and 50 percent, particularly 30 percent.

31. The welding torch (10) according to claim 27, wherein the feed device (32) is eccentrically arranged on the contact tube (30) such that the central axis of the bore (40) of the end piece (36) is inclined relative to the central axis of the bore (33) of the contact tube (30).

32. The welding torch (10) according to claim 27, wherein the end piece (36), at one end, has a transition zone (37) for receiving one end of the feed device (32).

33. The welding torch (10) according to claim 32, wherein the transition zone (37) is formed by a recess (38), the diameter of which substantially corresponds to the outside diameter (39) of the feed device (32).

34. The welding torch (10) according claim 32, wherein the transition zone (37) of the end piece (36) is fixedly connectable to the feed device (32).

35. The welding torch (10) according to claim 32, wherein the transition zone (37) of the end piece (36) is detachably connectable to the feed device (32).

36. The welding torch (10) according to claim 27, wherein the end piece (36) has a web (44) on the end opposing the transition zone (37).

37. The welding torch (10) according to claim 36, wherein the web (44) is designed as a centering ring for the guide bore (34), the outside diameter of the web (44) being slightly smaller than the diameter of the guide bore (34) of the contact tube (30).

38. The welding torch (10) according to claim 36, wherein the web (44) and the transition zone (37) are connected with each other via a connecting member (42).

39. The welding torch (10) according to claim 38, wherein the connecting member (42) has a smaller outside diameter than the web (44).

40. The welding torch (10) according to claim 36, wherein the outside diameter of the end piece (36) is designed to be tapering from the transition zone (37) in the direction of the web (44) towards the connecting member (42).

41. The welding torch (10) according to claim 33, wherein the recess (38) conically passes into the bore (40) of the end piece (36).

42. The welding torch (10) according to claim 27, wherein the whole web (44) of the end piece (36) and a portion of the connecting member (42) of the end piece (36) project into the guide bore (34) of the contact tube (30).

43. The welding torch (10) according to claim 27, wherein the feed device (32), at least in the region of the fixing thereof to the end piece (36), is designed to be flexible, particularly as a flexible coil.

44. The welding torch (10) according to claim 27, wherein the feed device (32), at least in the region of the fixing thereof to the end piece (36), is formed by a material having a high thermal resistance.

45. An end piece (36) for a device (32) for guiding a welding wire (13) into a welding torch (10), which end piece is fastenable to that end of the feed device (32) that is positioned in the guide bore (34) of a contact tube (30), and which end piece (36) is made of an electrically conductive material and is provided with a bore (40) for the welding wire (13), wherein the end facing the guide bore (34) of the contact tube (30) is designed for a rotatable and pivotable connection within the guide bore (34) of the contact tube (30).

46. The end piece (36) according to claim 45 for a welding torch (10).

47. A contact tube (30) having a bore (33) for the welding wire (13) and a guide bore (34) for receiving the welding wire (13) fed and for forwarding the latter to the bore (33), wherein the transition zone between the guide bore (34) and the bore (33) is formed by a dent (49) for rotatably and pivotally receiving an end piece (36) of a device (32) for feeding a welding wire (13).

48. The contact tube (30) according to claim 47, wherein the dent (49) is designed to be substantially spherical for receiving a sphere (50) on the end piece (36).

49. The contact tube (30) according to claim 48, wherein the diameter of the sphere (50) is slightly smaller than the diameter of the dent (49).

50. The contact tube (30) according to claim 47 for a welding torch comprising an end piece (36) for a device (32) for guiding a welding wire (13) into a welding torch (10), which end piece is fastenable to that end of the feed device (32) that is positioned in the guide bore (34) of a contact tube (30), and which end piece (36) is made of an electrically conductive material and is provided with a bore (40) for the welding wire (13), wherein the end facing the guide bore (34) of the contact tube (30) is designed for a rotatable and pivotable connection within the guide bore (34) of the contact tube (30).
